(19) United States
(12) Patent Application Publication
(10) Pub. No.: US 2002/0056112 A1
(43) Pub. Date: May 9, 2002

(54) Home digital assistant

(76) Inventors: Vincent Dureau, Palo Alto, CA (US); Joel Zdepski, Mountain View, CA (US); Jan Steenkamp, Woodside, CA (US); Ludovic Pierre, San Francisco, CA (US)

Correspondence Address: Mark L Berrier, Conley Rose & Tayon P C, P O Box 398, Austin, TX, 78767-0398, US

(21) Appl. No.: 09/534,672

(22) Filed: Mar. 24, 2000

Related U.S. Application Data
(60) Provisional application No. 60/137,616, filed on Jun. 3, 1999.

(51) Int. Cl. H04N 7/18

(52) U.S. Cl. 725/78

(57) ABSTRACT

A home digital assistant which, in one embodiment, is coupled by a local communication link to the receiver of an interactive television system. The home digital assistant is configured to enable a user to obtain information from and to interact with the interactive television system. The interactive television system includes a broadcast station and one or more receiving stations which are coupled to the broadcast station by a broadcast communication link. A broadcast signal which includes data targeted to the home digital assistant is transmitted from the broadcast station to the receiving stations over the broadcast link. The receiving stations separate the data targeted to the home digital assistant from the remainder of the signal and transmit this data to the home digital assistant over the local communication link. The data may be application code, raw data, streaming audio or video, triggers, control information, or other types of data. The home digital assistant can store, execute, display, play or otherwise use the data. In one embodiment, the home digital assistant can transmit information such as user input, control data or the like back to the receiver.

### RELATED APPLICATIONS

This application is a continuation in part of the provisional patent application entitled “NETWORKING SMART TOYS”, by Vincent Dureau, Ser. No. 60/137,616, filed Jun 3, 1999.

### BACKGROUND OF THE INVENTION

1. Field of the Invention

The present invention relates generally to a system and method for using a portable computing device to interact with a data distribution system such as an interactive television broadcast network

2. Description of the Relevant Art

Handheld computing devices (also referred to as “palmtops,” “personal digital assistants,” or simply “PDAs”) generally provide some combination of personal information management, database functions, word processing or spreadsheet functions. Users of these devices may also own personal computers (PCs) which run applications that provide similar functions and manage the same sort of data. Users who have both handheld devices and PCs normally want the data on each of these devices to be synchronized.

Systems and methods have therefore been developed to allow synchronization of handheld devices with PCs. As a result, users may be able to manage or manipulate data on one device, synchronize the data with that stored in a second device, and then continue working with the data on the second device. Handheld devices therefore allow users to perform some office-related tasks when they are away from their PCs.

Although handheld devices can be useful to allow users to work or organize data when they are outside the office, the functionality of these devices is typically limited to data management or other business-related tasks. It would be desirable to enable these devices to be used in a wider range of circumstances. For example, it would be useful to configure a handheld device to interact with devices other than PCs. It would also be useful to be able to use a handheld device for household tasks, such as obtaining and storing information relating to television shows, allowing users to interact with television shows, controlling interactive television systems, and the like.

### SUMMARY OF THE INVENTION

One or more of the problems outlined above may be solved by various embodiments of the present invention. In one embodiment, a remote device (a “home digital assistant”) works cooperatively with an interactive television system to provide assistance with personal and household tasks. The interactive television system includes a broadcast source which transmits data over a broadcast link to a receiver. The receiver, in turn, transmits data over a local communication link to the digital assistant. These communication links may be bidirectional so that the home digital assistant can transmit data to the receiver and the receiver can transmit data to the broadcast source.

In one embodiment, the local link between the home digital assistant and the receiver employs radio frequency (RF) transceivers. The transceivers provide a means to easily and seamlessly establish a bidirectional link between the receiving station and the home digital assistant. The broadcast link may employ satellite links or other common broadcast media. Various types of information may be transmitted from the broadcast source to the receiver and then to the home digital assistant. This information may include program applications, textual information, triggers which initiate actions in the home digital assistant, and any other type of information. The system may be used to transmit information unidirectionally to the home digital assistant, or the home digital assistant may be used interactively to provide input to, or even control, the receiver.

Various additional embodiments are described below and still others may be derived from the disclosure of this application. The invention is not intended to be limited to the embodiments described herein, but is instead intended to include any variations which fall within the scope of the claims.

### BRIEF DESCRIPTION OF THE DRAWINGS

Other objects and advantages of the invention will become apparent upon reading the following detailed description and upon reference to the accompanying drawings in which:

FIG. 1 is an illustration of the operation of the home digital assistant in conjunction with a set-top box.

FIG. 2 is a block diagram illustrating the flow of data between a broadcast station, a receiving station and a home digital assistant in one embodiment of the invention.

FIG. 3 is a block diagram of an interactive television system in one embodiment of the invention.

FIG. 4 is a block diagram of the components of a home digital assistant in one embodiment of the invention.

FIG. 5 is a block diagram of the components of a broadcast station in one embodiment of the invention.

FIG. 6 is a block diagram of the components of a receiving station in one embodiment of the invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

The invention generally comprises a remote device (which will be referred to herein as a home digital assistant) and methods of using the remote device. In one embodiment, the system comprises a home digital assistant which is coupled by a local communication link to the receiver of an interactive television system. The interactive television system includes a broadcast station and one or more receiving stations which are coupled to the broadcast station by a broadcast communication link. Television programming, interactive applications and other information can be transmitted from the broadcast station to the receiving stations over the broadcast link. Each of the receiving stations may also be coupled to the broadcast station by a return path which allows information to be transmitted from the receiving stations back to the broadcast station. The receiving station includes a receiver which can transmit information to the home digital assistant over the local communication link. The home digital assistant and receiver can communicate either bidirectionally or unidirectionally (from the receiver to the home digital assistant.)

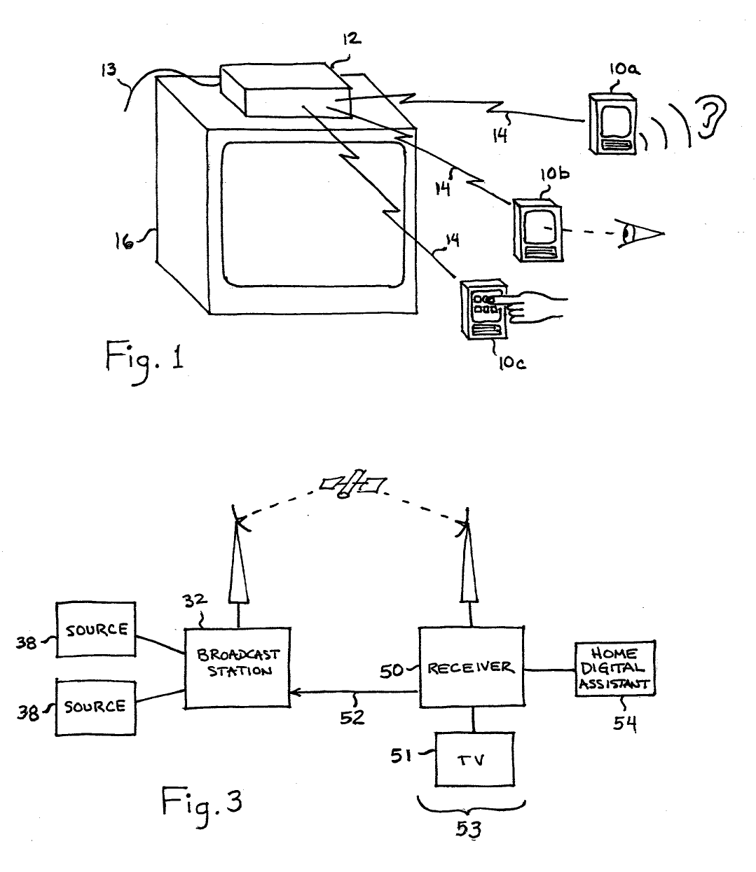

Referring to FIG. 1, one embodiment of the invention is illustrated. Home digital assistant 10 is coupled to a receiver 12 which, in this embodiment, is a set-top box. (For the sake of brevity, the three home digital assistants identified as 10a, 10b and 10c will be collectively referred to by the single reference numeral 10.) Receiver 12 accepts an interactive television broadcast signal via cable 13. The signal comprises data which may be targeted to either a television, the receiver, or the home digital assistant. Cable 13 forms part of the broadcast network or broadcast communication link (not shown) which couples the receiver to the broadcast station. The broadcast network will be described in more detail below.

Receiver 12 separates the received broadcast signal into its various components. Generally speaking, these signal components may include: audio and video data targeted to a television 16; receiver data targeted to receiver 12; and home digital assistant data targeted to home digital assistant 10. The audio and video data may comprise ordinary television audio and video (e.g., NTSC or other standard-format television signal). The receiver data may include control information which affects the operation of receiver 12, interactive applications which execute on the receiver, or other data which is normally provided to the receiver to perform various functions aside from displaying normal television audio/video. The data for home digital assistant 10 may consist of application downloads, notification signals, control signals, or any other information suitable for use by the home digital assistant. (It should be noted that, in the various embodiments of the invention, the broadcast signal need not include all of these types of information.)

In one embodiment, home digital assistant 10 is coupled to receiver 12 by an RF transceiver system. The RF transceiver system forms a wireless local communication link between home digital assistant 10 and receiver 12. The RF transmissions between home digital assistant 10 and receiver 12 are indicated generally as 14. In one embodiment, the local communication link is established automatically when home digital assistant 10 is within range of receiver 12. In other embodiments, the user may be required to initiate the link. Data, programming and other information may be communicated back and forth between home digital assistant 10 and receiver 12 without the need to manually connect the two using, for example, a cable which has a connection to the receiver on one end and a receptacle for accepting the home digital assistant on the other end. (It should be noted that other types of transceivers, e.g. infrared, or even cable connections can be used in other embodiments to establish the communication link.)

Several of the uses of home digital assistant 10 are illustrated in FIG. 1. Home digital assistant 10a depicts generation of audible information to which a user can listen. This information may, for example, consist of streaming audio which is transmitted from receiver 12 to come digital assistant 10a. Home digital assistant 10b depicts the display of visual information to a user. This information may be displayed while the user is watching a television program, or it may be stored for later use. The displayed information may have been transmitted directly from receiver 12, or it may be produced by home digital assistant 10b in response to signals transmitted by receiver 12. Home digital assistant 10c depicts a user providing input information to receiver 12 through the home digital assistant. This information may consist, for example, of raw data, control data or other information, and may be input using fixed keys or touch screen keys on the home digital assistant. (It should be noted that these uses of the home digital assistants are just several examples, and many other uses are possible.)

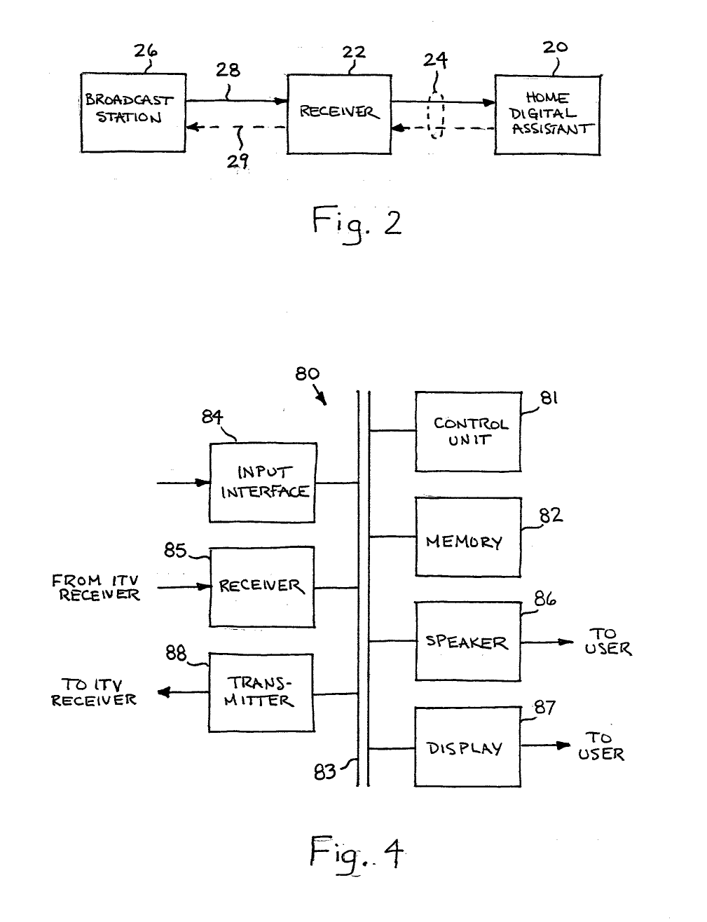

Referring to FIG. 2, a block diagram illustrating the flow of data in the system in one embodiment of the system is shown. Broadcast station 26 transmits information to receiver 22 via a unidirectional broadcast link 28 in this embodiment. (Although broadcast station 26 can broadcast information to many receivers via broadcast link 28, only one receiver is depicted in the figure.) Broadcast link 28 provides an efficient means to distribute information to a large number of subscribing receivers. Each receiver and home digital assistant can filter the broadcast data to achieve selective downloading of particular information, as will be discussed in more detail below. In the depicted embodiment, receiver 22 can transmit information to broadcast station 26 using return path 29. In various embodiments, return path 29 may comprise a telephone line, a network connection, or even a portion of the bandwidth of the broadcast link. It should be noted that it is not necessary to include return path 29 in all embodiments. In FIG. 2, it can be seen that information is transmitted from receiver 22 to home digital assistant 20 via communications link 24. Although the system can function without the transmission of any information from home digital assistant 20 back to receiver 22, some embodiments may include a return path in communications link 24 to allow a bidirectional exchange of information, as shown by the dashed line in the figure.

Referring to FIG. 3, an interactive television system in one embodiment of the invention is shown. Broadcast station 32 is coupled to one or more data sources 38. Data sources 38 may be any one of a number of sources which may provide information to broadcast station 32. For example, they may include remote television feeds, videotape recorders, mass storage devices or Internet gateways. Data sources 38 may be coupled to broadcast station 32 by any appropriate means. A remote television feed, for example, may be coupled to the broadcast station by a satellite transmission link, while an Internet gateway is coupled to the broadcast station by means of a modem and an ordinary telephone line. (It should also be noted that, in some embodiments, the broadcast station may be replaced by another type of signal source.) The receiving station is operatively connected to the broadcast station by a broadcast channel. This broadcast channel can utilize various transmission media. Although FIG. 3 depicts the broadcast channel as a satellite transmission link, it is contemplated that any broadcast medium, including non-satellite, CATV (cable), telco (telephone), MMDS (microwave) and terrestrial transmissions, may be used. Likewise, the broadcast may use various formats, such as digital, switched packet transmissions, or vertical blanking interval (VBI) transmissions. The broadcast channel provides a transmission path which is typically unidirectional, from the broadcast station to the receiving station. The broadcast station and receiving station are also connected by a return path 52. The return path provides a transmission path which is typically bidirectional, allowing the receiving station to transmit data to the broadcast station and vice versa, and often has very limited bandwidth. The return path may also be used unidirectionally in some systems. The return path typically consists of a pair of modems, one in the receiving station and one in the broadcast station, each connected to a standard telephone line. Other means for establishing a return path, e.g., using a portion of the bandwidth of the broadcast channel, are also contemplated.

Receiving station 53 includes a receiver 50 and a television 51. In this embodiment, the receiver is implemented in a set-top box. (Although the term “set-top box” is used below, it is understood that this term refers to any receiver or processing unit for receiving and processing a transmitted signal and conveying the processed signal to a television or other monitor.) The set-top box may be in a housing which physically sits on top of a television, it may be in some other location external to the television (e.g., on the side or back of the television or remotely located from the television), or it may be incorporated into the television itself. Set-top box 50 serves to demodulate the signal received from the broadcast station and to separate the application from the audio/video (television program) portion of the signal. The set-top box executes the application and combines the audio and video portions of the television program with video and/or audio generated by the application, as required by the application. The modified television program signal is then passed on to television 51. Television 51 may be a television or a video monitor employing any suitable television format (e.g., NTSC or HDTV), or it may be replaced by other devices, such as a video recorder. Receiving station 53 may also include a return path 52. Return path 52 may be utilized by an application to provide data to the broadcast service provider. The return path is commonly a modem within the set-top box connected to a standard telephone line. A corresponding modem at the broadcast station is also connected to the telephone line to receive data from the receiving station.

For the purposes of this disclosure, the broadcast medium may comprise a videotape, digital video disc (DVD) or other type of recording medium which can be distributed to a plurality of users. Such a recording would contain the same or equivalent programming to that found in the interactive television signal described above. As noted above, this information need not include predetermined types of information, but may include any information suitable for a particular embodiment. In embodiments using recorded media, it should be noted that the functions of both the signal source and the receiving station may be implemented in the media player. In such an embodiment, the receiving station (e.g., VCR) would receive the broadcast signal from the recorded media (e.g., videotape.)

Home digital assistant 54 is coupled to receiver 50 by a local transmission medium. Preferably, the local communication link between home digital assistant 54 and receiver 50 is a bidirectional, wireless link. Such a link may be implemented in one embodiment using RF transceivers in the receiver and home digital assistant. In other embodiments, the communication link need not be bidirectional, and it need not be wireless.

Referring to FIG. 4, a block diagram illustrating the functional components of the home digital assistant in one embodiment of the invention is shown. The home digital assistant is designated generally as 80. Home digital assistant 80 includes a control unit 81 and memory 82, each of which is coupled to bus 83. Control unit 81 may comprise a microprocessor, microcontroller, digital signal processor (DSP), or some other type of software instruction processing device. Control unit 81 is configured to perform one or more applications which are stored in memory 82. Memory 82 may include memory units which are static (e.g., SRAM), dynamic (e.g., DRAM), volatile or non-volatile (e.g., FLASH), as required to support the functions of the home digital assistant. Input interface 84, receiver 85, transmitter 88, speaker 86 and display 87 are also coupled to bus 83 to provide input and output means. Data can be input from the user via input interface 84 or from the set-top box via home digital assistant receiver 85. The data can be used in the execution of applications by control unit 81. Receiver 85 can also used to input application code. Thus, home digital assistant 80 can be re-programmed by storing new applications in memory 82 (these new applications can then be executed by control unit 81.) It should be noted that the specific components of the home digital assistant described herein and the specific configuration of the components are illustrative. Other embodiments may incorporate a different set of components or may configure them in a different manner.

In one embodiment of the invention, receiver 85 is an RF receiver. Similarly, Transmitter 88 is an RF transmitter. Receiver 85 provides a data conduit from the set-top box to the home digital assistant. Receiver 85 can be used to convey raw data, control signals, application code and other information to the home digital assistant. User input interface 84 may comprise a keypad, touch screen, and/or any other suitable means for entering information to the home digital assistant. Transmitter 88 provides a data conduit for transmitting information from the home digital assistant to the set-top box. Transmitter 88 enables the home digital assistant to convey control signals, upload user information or transmit other information to the set-top box. Receiver 85 and transmitter 88 form the transceiver of the home digital assistant. The transceiver provides a bidirectional local communication link between the home digital assistant and an information source such as the set-top box of the interactive television system.

The home digital assistant is configured to convey information to the user through speaker 86 and display 87. It is contemplated that display 87 may conveniently be combined with user input interface 84 in a touch screen display. In this case, an LCD display could be configured to produce an image including one or more selectable items and the touch screen would be configured to respond to user selection of these items. Maps of the displayed keys can be downloaded to the home digital assistant from the receiver. The touch screen could be used alone or in combination with a separate keypad.

Although transmitter 88 and receiver 85 operate using RF transmissions in the embodiment described above, it should be noted that other types of communication links can also be used. For example, an alternate embodiment may employ infrared transmitters and receivers. Infrared devices would provide line-of-sight communications between the home digital assistant and the set-top box. It is also contemplated that the local communication link could be provided by a physical connection, such as a cable or other hardwired connection. Because of the limitations of the hardwired and infrared communication links, the RF system is preferred.

As indicated above, home digital assistant 80 includes a speaker 86 and a display 87 for providing information to the user. Speaker 86 and display 87 are coupled to bus 83 and may be driven by interactive applications executed by control unit 81 or by signals which are simply passed through the home digital assistant from receiver 85 to the speaker or display. If the speaker and/or display are driven by applications, the applications may trigger the speaker to play pre-recorded words or phrases in response to signals received from the set-top box, the user input interface, or the application itself. Likewise, the display may show previously stored images in response to these same stimuli. Alternately, the home digital assistant may be configured to receive sound or image data from the set-top box and pass it on to the speaker and/or display with minimal processing. This may be referred to as streaming audio and/or video. Streaming audio/video may be employed when there is too much audio/video data to conveniently store in the home digital assistant (i.e., when storage of the data would require a large amount of memory.) The home digital assistant may simply buffer a small amount of the received data and convey it to the speaker/display.

The home digital assistant described above is just one of the many embodiments which are possible. This embodiment is intended to be illustrative, and other embodiments may not include all of the features described above. Still other embodiments may include features which are not described above. For example, the home digital assistant may includes a number of additional features which are best described in the context of the operation of the overall system and which will be described below in the portion of the disclosure detailing system operation.

Because the embodiment of the home digital assistant described above is used in conjunction with an interactive television system, the broadcast station and receiving stations of the system will be described in more detail below.

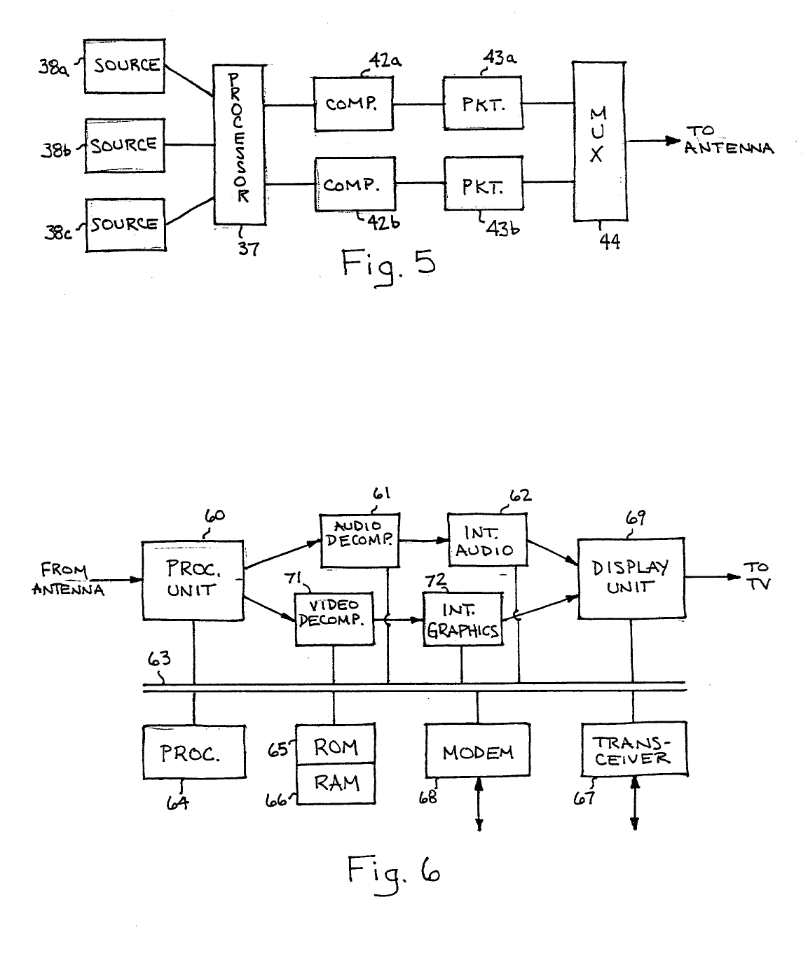

Referring to FIG. 5, a block diagram of the broadcast station in one embodiment of invention is shown. Data sources 38 may provide such different types of information as television programs, interactive application code, Internet web pages, control information or raw data. Typically, television programs are combined with other types of information and transmitted over the broadcast channel to the receiving stations. This combined signal is referred to herein as an interactive television signal. While the embodiments described in this disclosure are primarily configured to operate on a signal which includes television programming, “interactive television signal” is intended to encompass signals which do not necessarily include television programming.

Processing unit 37 of the broadcast station receives data from the respective data sources 38. Processing unit 37 may simply pass through the information provided by data sources 38, or may combine one or more portions of the information. Processing unit 37 may also be configured to modify the information or add its own control data. The information provided by data sources 38 may be compressed by compression units 42 in order to conserve bandwidth. Virtually any other data to be transmitted by the broadcast station can be compressed as well. Compression units 42 may use any suitable compression algorithm. Alternatively, some information may not be easily or effectively compressed, so some of the information may bypass compression units 42. The information is then conveyed to packetization units 43. (Although not shown in the figure, the system may also include scrambling circuitry or other means to control access to the broadcast signal.) Packetization units 43 format the information into packets for transmission over the broadcast channel. The packets of different data sources may then be combined by multiplexer 44, which time-multiplexes the packets before they are transmitted over the broadcast channel.

The broadcast station may include a processor, micro-controller, digital signal processor (DSP), or other type of processing device for selecting data sources, determining how to process information from the data sources, and controlling the other functions of the broadcast station. The processor may be coupled to the other components in the system by an internal bus or by other means. The processor will typically also be coupled to a memory device which stores instructions and data used by the processor. It should also be noted that the components of the broadcast station may be configured in different arrangements than described herein (e.g., some components may be combined or implemented in software.) The other parts of the system (i.e., receiving station and home digital assistant) may be implemented in varying configurations as well.

In one embodiment, the broadcast station is configured to transmit certain pieces of data in a cyclic manner. For the purposes of this description, these pieces of data are referred to as modules. The modules may include application code, web pages, or any other kind of data. Because the modules are transmitted cyclically, a set of modules which is repetitively transmitted is often referred to as a carousel. The modules of a carousel are typically transmitted in combination with television programming. One or more of the modules may be related to the content of this television programming. As a result, a user who is watching a television program may receive applications which are executed during the program to promote user interaction with the program, to provide particular signals during the program, or to perform other actions related to the program. In other instances, of course, modules may be completely unrelated to the television program (or other information) with which they are transmitted to the user.

Referring to FIG. 6, a block diagram of the set-top box in one embodiment of invention is shown. The various components of the set-top box are each coupled to system bus 63 and are configured to receive control signals from control system 64. It is contemplated that these and the other components of the set-top box may also be directly interconnected or consolidated into one or more physical units, as a matter of design choice. It is also contemplated that the functions of the set-top box components may be distributed among the components in a manner different from that described herein, as a matter of design choice.

As noted above, the audio/video stream is typically compressed prior to transmission by the broadcast station using a compression algorithm such as one of the Motion Picture Expert Group (MPEG) compression standards. The transmission signal from the broadcast station arrives at receiving station 53. The transmission signal is fed to set-top box 50 and input to signal processing unit 60. Signal processing circuit 60 breaks down the transmission signal into component parts such as the audio portion of the signal, the video portion of the signal and interactive applications which may have been injected into the signal at the broadcast station prior to transmission. The audio portion of the signal is routed to audio decompression unit 61. Audio decompression unit 61 then reconstructs the audio portion of the television program. The video portion of the signal is routed to video decompression unit 62, where the video portion of the television program is reconstructed. The outputs of audio and video decompression units 61, 62 are connected to interactive audio unit 71 and interactive graphics unit 72, respectively. Interactive graphics unit 72 may overlay interactive graphics generated by interactive applications onto the broadcast video and route the combined video to display unit 69. Interactive audio unit 71 may combine audio generated by interactive applications with the broadcast audio and direct the combined audio to display unit 69, which formats the audio and video signals and produces an output signal for a television.

The set-top box also has a transceiver 67 coupled to bus 63. Transceiver 67 may consist of an RF receiver and an RF transmitter which are configured to communicate with the receiver and transmitter (i.e., the transceiver) of the home digital assistant. The two transceivers form a communications link between the set-top box and the home digital assistant through which data and programming may be exchanged. Transceiver 67 may transmit information to or from control system 64, or it may be configured to allow the information to simply pass through the set-top box, effectively establishing a link between the home digital assistant and the broadcast station. For example, speech data may be downloaded from the broadcast station, through the set-top box and to the home digital assistant. This allows the set-top box to be configured with a memory system which is too small to hold all of the data being downloaded (which may consist of one or more very large files.) The set-top box may nevertheless be able to buffer some of the speech data to enable continuous transmission of the data to the home digital assistant. Likewise, the home digital assistant may be configured to allow information such as speech data to be passed through to a speaker without the need to store the data (hence, without the need for the corresponding memory space.)

Control system 64 may include a microprocessor, micro-controller, digital signal processor (DSP), or some other type of software instruction processing device. Control system 35 is coupled to read-only memory (ROM) 65 and random-access memory (RAM) 66 through system bus 63. When the set-top box is turned on, control system 64 executes operating system code which is stored in ROM 65. The operating system code of the set-top box executes in the same manner as the operating system code of a typical personal computer (PC) and enables the set-top box to perform interactive functions through the execution of application code. The set-top box also includes modem 68, which provides a return path by which viewer data can be transmitted to the broadcast station.

Interactive applications may require that the audio and video portions of the television program be combined with interactive graphics and/or audio before they are transmitted to television 51. Control system 34 may therefore transmit control signals to interactive audio and graphics units 71, 72 in order to combine the audio and video of the television program with the interactive audio and video for output to display unit 69 and television 51. The function of combining of the audio and video of the interactive application and the television program may be allocated to the interactive audio and graphics units 71, 72, the display unit 69, the decompression units 61, 62, the control system 64, or one or more other components, depending on the design of the particular set-top box. Input which may be required by the interactive applications can be provided through the home digital assistant via its communications link to the set-top box.

The interactive television system described above provides an easy-to-use and intuitive interface between a home digital assistant and a source of programming information. In one embodiment, programming information is broadcast from a broadcast station to a receiving station and is then transmitted from the receiving station to the home digital assistant. Thus, the receiving station functions as a programming unit for the home digital assistant. Because the system utilizes RF transceivers to transmit the programming information from the receiving station to the home digital assistant, the user does not have to physically connect the home digital assistant to the receiving station. If the home digital assistant is within the transmitting range of the receiving station, the home digital assistant is in communication with the receiving station and can receive programming information. The home digital assistant can therefore transition seamlessly from normal operation to a download mode. This feature is particularly useful when the user is a unfamiliar with electronic equipment and may not properly connect the wires or cables between the home digital assistant and the receiving station. Additionally, because the wires/cables are being connected to electronic equipment, doing so presents a risk of electrical shock to the person who connects them, so the use of a wireless link for downloads is inherently safer. (Although it may be preferable to use a wireless transceiver, it should be noted that some embodiments may use a physical, e.g., wire, connection between the home digital assistant and the receiving station.)

The use of a broadcast network (e.g. an interactive television system) to distribute programming information for the home digital assistant eliminates the need to establish a point-to-point connection with a manufacturer's website or electronic bulletin board in order to download this information. The user does not need a personal computer to establish the download link and does not have to be concerned with disruptions caused by busy telephone lines or heavy internet traffic. The broadcast network also allows transmission equipment and bandwidth to be shared. Further, because programming information is broadcast to the user on an existing television network, connecting to the programming unit (i.e., the receiving station) to the programming source is essentially effortless for the end user (i.e., the user of the home digital assistant.)

Although connecting to the programming unit may be effortless, some users may require assistance to initiate or control downloading of data to the home digital assistant once it is connected. Several features are incorporated into the system to provide this assistance. One of these features is a notification function. When the receiving station has data to be downloaded, it may transmit a notification signal. If the home digital assistant is within range of the receiving station, this signal will cause the home digital assistant to take a corresponding action to notify the user that the data should be downloaded. The home digital assistant may emit a sound (e.g. a beep) or play a prerecorded message indicating that the home digital assistant should be brought within the download range of the receiving station. (It should be noted that the notification signal may have a substantially greater range than the download signal.)

This feature may also be used to notify the user that a particular television program is being broadcast. In one embodiment, either the receiving station or the home digital assistant could be programmed to provide notification of the program to the user based on predetermined and/or preprogrammed information such as program guides, current time, time zones, zip codes or area codes. The receiving station and/or home digital assistant can be configured to download data to the home digital assistant while the user watches the television program. As noted above, programming or data can be downloaded to the receiving station or home digital assistant to assist the user in controlling the download. This assistance may take the form of audio cues (e.g., streaming through the home digital assistant) or visual cues (e.g., text or graphics presented on the home digital assistant display or overlaid on the television program).

In one embodiment, programming information is transmitted over the broadcast network in a cyclical manner. This can eliminate the need for a return path from the receiving station to the broadcast station. Because all of the available programming information is transmitted periodically, there is no need for the receiving station or the home digital assistant to send requests for particular programming information to the broadcast station (i.e. programming source.) In other words, at particular intervals, each application module or other piece of data will be broadcast again, whether it is requested/needed or not. The information needed by a particular home digital assistant is selected locally by accepting only particular pieces of information for downloading. The elimination of requests for particular modules eliminates the need for a return path through which the receiving stations can communicate with the broadcast station. Further, the elimination of the need to monitor such requests and provide responses thereto may substantially reduce the load on the broadcast station and thereby improve performance.

A potentially large number of program, data or other modules can be repetitively broadcast by the broadcast station. These modules may contain data designed for many uses. The data may be intended for use in interactive television applications or for use in devices other than home digital assistants. If such data is being broadcast, it is necessary to provide a means for selectively downloading or selectively storing particular ones of these modules which are intended to be downloaded to the home digital assistant. Even if all of the modules are designed for downloading to the home digital assistant, some of the modules may be more useful or more appropriate for particular users. For example, interactive speech data which is designed for an adult may be more sophisticated than speech data designed for a child. It is therefore useful to provide a means for selectively downloading or receiving particular ones of the modules that are designed for the home digital assistant.

One way to selectively download modules is to construct user preferences or profiles and to filter downloaded data using this information. User profiles may be based on explicitly entered user information and/or historical use information. An example of explicitly entered user information would be a person's age. As indicated above, modules which are appropriate for an adult may not be appropriate for a child. Thus, although the user may not explicitly select particular modules to be downloaded, the modules may be filtered to effectuate a download of only age-appropriate data. An example of historical use data is the number of times a user has played particular games or used particular features of the home digital assistant. If a user has shown interest in certain games, the broadcast modules may be filtered to download only similar games. The home digital assistant may also be configured to select the least used programs for deletion to make room for new programming. Depending upon the memory and other resource requirements of such filtering, this may be implemented in the home digital assistant itself, in the receiving station or in the broadcast station. User data or profile information may be uploaded to the broadcast station to be used in filtering operations if the system incorporates a return path.

The features described above may be further illustrated in the following examples.

In one embodiment, the home digital assistant is programmed to remind the user to watch a specific television program. The home digital assistant stores program information, possibly including a program guide and time zone information, and has an internal clock which allows it to provide the reminder at the appropriate time. At the appropriate time, a notification signal is transmitted to the home digital assistant, which in turn signals the user to turn on the television program. The home digital assistant's reminder to the user may include instructions as to which program to watch or how to tune in the proper channel. Streaming audio or video may also be transmitted to the home digital assistant to provide instructions to the user.

In one embodiment, the receiving station may transmit a notification signal to the home digital assistant to indicate that the receiving station is ready to download data to the home digital assistant. The home digital assistant can then signal the user to take the home digital assistant within communication range of the receiving station. The home digital assistant may also be configured to transmit a signal to the receiving station in response to the notification signal indicating that the home digital assistant is ready to download data. The receiving station may then automatically initiate the download in response to the signal from the home digital assistant. In another embodiment, when the receiving station is tuned to a channel or a particular show that provides the download data, it transmits the download data regardless of whether the home digital assistant is within range or not. If the home digital assistant is within range of the receiving station, it downloads the data.

In one embodiment, the home digital assistant is not configured to transmit data to the receiving station. In this embodiment, the receiving station transmits data unidirectionally to the home digital assistant. The home digital assistant may, in effect, selectively download data by examining data which is cyclically transmitted by the receiving station and storing only those portions which would have been requested in a bidirectional system.

In one embodiment, a user brings the home digital assistant within programming range of the receiving station and selects the appropriate broadcast channel. A control application is downloaded to the receiving station at the same time as the data that may be downloaded to the home digital assistant. The control application is launched in the receiving station. The control application provides cues to the user for controlling the download. The cues may be text, graphics, audio or video and may provide instructions to the user. The user can select particular data to be downloaded based on the cues. The control application would then filter the data broadcast by the broadcast station, allowing only a portion of the data to be downloaded to the home digital assistant.

In one embodiment, the home digital assistant transmits a signal to the receiving station to notify the receiving station that the home digital assistant is within range. When the receiving station receives this signal, the receiving station tunes itself to a predetermined channel or web site from which it can retrieve the download data for the home digital assistant. The receiving station then downloads this data to the home digital assistant. In another embodiment, the receiving station may have already retrieved the data so that it may initiate a download of the data to the home digital assistant upon receipt of the notification signal from the home digital assistant. In another embodiment, the home digital assistant may transmit a signal to the receiving station to indicate the location from which the receiving station should retrieve the data. The home digital assistant may also transmit to the receiving station a piece of software which allows the receiving station to communicate with the home digital assistant, the user or the server that provides the download data. In any of these embodiments, the transmissions of data and/or signals may take place immediately, or they may be delayed, in order to accommodate unavailable transmission paths (e.g. the receiving station may be tuned to a different channel, or the return path may be unavailable at the time of the download.)

In one embodiment, the home digital assistant has a sufficient memory to store one or more applications. The home digital assistant is configured to receive data from the receiver which trigger the applications. That is, when the home digital assistant receives the trigger data, a corresponding application stored in the home digital assistant is launched, without having to wait for the application to be downloaded to the home digital assistant from the receiver. The trigger data may comprise a simple signal which does nothing more than trigger the launch of an application, or it may comprise more elaborate data such as an HTML page that triggers the launch of an HTML viewer which displays the page.

In one embodiment, the home digital assistant and interactive television receiver may work cooperatively to initiate or terminate applications or functions. For example, upon receiving a signal containing an interactive application, the receiver may need to terminate a currently executing application. The receiver may be configured to notify the home digital assistant prior to exiting the current application so that the home digital assistant can perform housekeeping procedures and exit its current application in anticipation of the receiver executing the newly received application. The receiver can then launch the new application and send a corresponding signal or application to the home digital assistant, which can in turn execute the corresponding function or application.

In one embodiment, the receiver is configured to receive radio broadcasts. Applications, control signals or other information can be broadcast to the receiver in the same way this information is broadcast in an interactive television system. When the information is received by the receiver, corresponding information is transmitted from the receiver to the home digital assistant.

In one embodiment, the home digital assistant comprises a reconfigurable remote control. The remote control can adapt itself to the currently displayed television program or a currently executing application. The remote control has a touch screen display on which a set of touchable keys corresponding to the program or application can be drawn. A map defining these keys can be downloaded from the receiver to the remote control. The remote control may be configured to allow the user to interact with a television program (e.g., by selecting answers to questions in a game show,) to provide input to an application, or even to control the functions of the receiver itself (e.g., by changing channels.)

In one embodiment, the home digital assistant can be configured as an electronic notepad. For example, as the user watches a cooking show, the recipe for a dish which is being prepared can be downloaded to the home digital assistant. The user can take the home digital assistant to the store to use as a shopping list for the recipe and can then use the home digital assistant in the kitchen to read the recipe as he or she is preparing the dish. As another example, lists of books or compact discs (CDs) could be downloaded to the home digital assistant while the user watches a cultural or educational television program relating to the same subject matter.

In one embodiment, the home digital assistant provides a means to obtain coupons. While the user watches a particular program or set of programs, the receiver may download coupons to the home digital assistant. These coupons may include product coupons, or they may be fidelity coupons. The user can take the home digital assistant to the grocery store to redeem the product coupons. The fidelity coupons can be accumulated in the home digital assistant, which can later be taken to a store where products can be obtained based upon the number of coupons accumulated.

In one embodiment, electronic coupons stored in the home digital assistant could be displayed on the screen of the home digital assistant as bar codes or some other type of machine-readable information. The bar codes could then be displayed by the home digital assistant and scanned by a cash register (or other device) to redeem the coupons. The home digital assistant could also be configured to communicate directly with the cash register by. This information could be communicated, for example, by an infrared transmitter in the home digital assistant, or through a data cable that plugs into a communication port of the home digital assistant.

In one embodiment, the home digital assistant can be configured to function as an individual interface or controller to a television system. If multiple users are watching television, each user can have a separate home digital assistant which allows the user to interact with the television system. Users may thereby independently provide input to, or receive information from the television system. For example, if the users are watching an interactive game show, the users may compete against each other, each answering questions through his or her respective home digital assistant. If the users are watching a sporting event, each of the users may access statistics relating to the event without interfering with the other users' enjoyment of the event. Information can also be communicated between the home digital assistants of multiple users. For example, if users are competing against each other in an interactive game, their scores may be displayed on each other's home digital assistants.

In one embodiment, the home digital assistant can be configured to allow a user to send and receive email. Emails broadcast through the interactive television system can be accessed by the addressee through his or her own home digital assistant. Multiple users can simultaneously access their own emails through separate home digital assistants. Similarly, multiple users can independently compose and send emails from their own home digital assistants, through the interactive television system, to other addressees. The home digital assistants can be configured to allow individual videoconferencing in a similar manner.

In one embodiment, the television system is configured to transmit information over an analog broadcast medium. In this embodiment, applications, control data and other information are transmitted to the receiver in the vertical blanking interval of the television signal. The receiver is configured to detect this information in the vertical blanking interval and to execute applications and/or transmit information to the home digital assistant in the same manner as a system which uses a digital broadcast medium.

While the present invention has been described with reference to particular embodiments, it will be understood that the embodiments are illustrative and that the invention scope is not limited to these embodiments. Many variations, modifications, additions and improvements to the embodiments described are possible. These variations, modifications, additions and improvements may fall within the scope of the invention as detailed within the following claims.

What is claimed is:

1. A home digital assistant comprising:
a control unit;
a memory coupled to said control unit; and
a transceiver coupled to said control unit and said memory;
wherein said transceiver is configured to receive first data from an interactive television system wherein said first data is targeted to the home digital assistant, and wherein said transceiver is configured to transmit second data to said interactive television system.

2. The home digital assistant of claim 1 wherein the home digital assistant is configured to function as a programmable remote control for said interactive television system.

3. The home digital assistant of claim 1 further comprising a programmable touch screen display, wherein the home digital assistant is configured to present a set of selection options on said display to enable a user to provide input to said interactive television system.

4. The home digital assistant of claim 1 wherein the home digital assistant is configured to receive information associated with a television program broadcast on said interactive television system and to store said information for later retrieval by a user.

5. The home digital assistant of claim 1 wherein the home digital assistant is configured to provide an independent user interface to said interactive television system, and wherein the home digital assistant is configured to enable a user to request and receive information which is currently being broadcast on said interactive television system.

6. The home digital assistant of claim 5 wherein said information is selected from the group consisting of: information associated with a currently broadcast television program; email information; and videoconferencing information.

7. The home digital assistant of claim 1 wherein the home digital assistant is configured to launch one or more applications in response to receiving one or more triggers from said interactive television system.

8. A method comprising:
transmitting a first signal from a signal source to a receiver, wherein said first signal includes remote device data;
separating said remote device data from the remainder of said first signal;
transmitting said remote device data to a first remote device; and
said first remote device performing a function in response to receiving said remote device data.

9. The method of claim 8 wherein said first signal includes television program data, wherein said remote device data is associated with said television program data, wherein said method further comprises displaying said television data on a television and wherein said function performed by said first remote device comprises providing said remote device data to a user while said television program is being displayed.

10. The method of claim 9 wherein said first signal further comprises receiver data, wherein the method further comprises said receiver separating said receiver data from the remainder of said first signal and using said receiver data in said receiver.

11. The method of claim 9 further comprising filtering said remote device data prior to providing said remote device data to said user.

12. The method of claim 8 wherein said function comprises an action selected from the group consisting of: launching an application; downloading an application; displaying said remote device data; playing said remote device data; storing said remote device data; providing a notification signal to a user; reprogramming said remote device; drawing a set of touchable keys on a touch screen; accumulating fidelity coupon data; and storing product coupon data.

13. The method of claim 8 wherein said transmitting said remote device data to said first remote device and said first remote device performing a function in response to receiving said remote device data comprises said receiver and said first remote device communicating interactively.

14. The method of claim 13 further comprising a second remote device interactively communicating with said receiver independent of said first remote device.

15. A system comprising:
a signal source;
a signal receiver coupled to said signal source;
a television coupled to said signal receiver; and
a first remote device coupled via a communication link to said signal receiver;
wherein said signal source is configured to provide a first signal wherein said first signal includes audio data, video data, receiver data and remote device data;
wherein said signal receiver is configured to transmit said audio data and video data to said television;
wherein said signal receiver is configured to transmit at least a portion of said remote device data to said first remote device; and
wherein said first remote device is configured to perform a function in response to receiving said portion of said remote device data.

16. The system of claim 15 wherein said signal source is selected from the group consisting of: an interactive television broadcast station; a radio broadcast station; and a media player configured to generate said first signal from a prerecorded medium.

17. The system of claim 15 wherein said first remote device is configured to transmit user input to said signal receiver.

18. The system of claim 17 wherein said first remote device comprises a remote control and wherein said user input comprises control data for controlling one or more functions of said signal receiver.

19. The system of claim 15 wherein said function performed by said first remote device is selected from the group consisting of: downloading an application; launching an application; storing said portion of said remote device data; displaying said portion of said remote device data; playing said portion of said remote device data; providing a notification signal to a user; reprogramming said remote device; drawing a set of touchable keys on a touch screen; accumulating fidelity coupon data; and storing product coupon data.

20. The system of claim 15 wherein said first remote device is configured to interactively communicate with said signal receiver, wherein the system further comprises at least one additional remote device configured to interactively communicate with said signal receiver independent of said first remote device.
